(19) United States
(12) Patent Application Publication
(10) Pub. No.: US 2005/0032644 A1
(43) Pub. Date: Feb. 10, 2005

(54) Binder selection for coated photographic base stock

(76) Inventors: Gregg L. Brelsford, Paducah, KY (US); Dean R. Johnson, Columbia, MD (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/870,675

(22) Filed: Jun. 17, 2004

Related U.S. Application Data
(60) Provisional application No. 60/479,118, filed on Jun. 17, 2003.
(60) Provisional application No. 60/479,119, filed on Jun. 17, 2003.
(60) Provisional application No. 60/478,991, filed on Jun. 17, 2003.

(51) Int. Cl. B41M 5/20

(52) U.S. Cl. 503/227

(57) ABSTRACT

A coated paper, particularly useful as a photobase paper, includes a pigment coating on at least one side thereof wherein the pigment coating comprises an acrylic binder and the coated paper exhibits a stability comparable to the uncoated base paper. Methods for manufacturing the coated paper having a roughness of no more than 3 microns are also described.

### CROSS REFERENCE TO RELATED APPLICATIONS

This application claims the benefit of U.S. Provisional Application No. 60/479,118, filed Jun. 17, 2003, which is related to U.S. Provisional Application No. 60/479,119, entitled “SMOOTH BASE STOCK COMPOSED OF NONSTANDARD FIBERS” and U.S. Provisional Application No. 60/478/991/entitled “PIGMENT SELECTION FOR COATED PHOTOGRAPHIC BASE STOCK.” The disclosures of these provisional applications are hereby incorporated by reference.

This application is related to contemporaneously filed U.S. application Ser. No. ______, entitled “SMOOTH BASE STOCK COMPOSED OF NONSTANDARD FIBERS” and U.S. application Ser. No. ______, entitled “PIGMENT SELECTION FOR COATED PHOTOGRAPHIC BASE STOCK.” The disclosures of these applications are hereby incorporated by reference.

### FIELD OF THE INVENTION

The present invention relates to coated photographic base stocks and, more particularly, to coated photographic base stocks wherein the coating comprises an acrylic binder. The acrylic binder provides image stability and improved resistance to edge penetration during the developing process.

### BACKGROUND OF THE INVENTION

To ensure image and color quality of a printed photographic image, the color of the base stock upon which the photographic paper is formed must maintain its whiteness and brightness when subjected to varying conditions of light intensity. For photographic paper using a base stock that has been coated with an inorganic mineral based coating prior to extrusion or lamination with a polymer layer, the binder used in the coating must provide color stability and resistance to edge penetration by developer solutions comparable to an uncoated base stock.

Photographic base stock is designed for color stability by control of the materials used in its manufacture. Colorants and whitening agents used must be stable under variable lighting conditions. A coated photographic base stock is useful for providing a smoother base stock for extrusion or lamination of a polymer layer to one or both sides and subsequent application of other specialty coatings. To provide this extra smoothness, coatings containing inorganic minerals are suggested in U.S. Pat. No. 6,482,581 and U.S. Pub. No. 2001/0026869. These references disclose the use of inorganic minerals such as calcium carbonate and clay materials. It is known in the art of coating paper that additional materials must be used in coatings to adhere the coating pigments to themselves and to the substrate upon which the coating is applied. Materials used for this purpose are generally known as binders and can be synthetic or natural. Coatings used in the examples of the references noted above contained synthetic binders of styrene-butadiene chemistry and starch, a natural binder. Starch is used as a binder in uncoated photo base stock to provide strength to the surface of the base stock.

The binder in a coating for photographic base stock must perform additional functions compared to a binder in a coating used for typical coated papers where interactions with printing inks and printing processes are critical. When photographic images are developed, the photographic paper passes through a series of liquid solutions; a developer bath, a stop bath, and water wash baths. If the developer solution is allowed to penetrate into the edge of a photograph, an objectionable discoloration will result. If calcium ions leach into the developer solution from the photographic paper, the calcium ions will decrease the useful life of the developer solution. To inhibit edge penetration and calcium extraction, elevated amounts of binder are required in a coating for photographic base stock. With more binder in the coating, color stability of the binder becomes more critical. Binders of styrene butadiene chemistry do not possess the requisite color stability. With exposure to light, the color of coatings prepared using styrene-butadiene binders will shift towards yellow, significantly affecting the brightness and whiteness appearance of the base stock.

### SUMMARY OF THE INVENTION

The present invention relates to photographic base stock comprising a pigment coating containing binders of acrylic based chemistry. The binders useful in accordance with the present invention impart color stability to a coating comparable to an uncoated base stock. Coatings prepared using these binders also provide sufficient water resistance to inhibit edge penetration of developer, bind the coating pigments to control release of calcium ions into the photo developer, and promote good adhesion to an applied polymer coating.

In accordance with certain aspects of the present invention a coated photographic base stock is provided wherein the coating comprises an elevated amount of binder and yet provides non-yellowing color stability.

### BRIEF DESCRIPTION OF THE DRAWINGS

FIG. 1 is a graph showing the change in L value as a function of exposure time for the examples in Table 1;

FIG. 2 is a graph showing the change in “a” value as a function of exposure time for the examples in Table 1;

FIG. 3 is a graph showing the change in “b” value as a function of exposure time for the examples in Table 1; and

FIG. 4 is a graph showing the change in brightness as a function of exposure time for the examples in Table 1.

### DETAILED DESCRIPTION OF THE INVENTION

All documents cited are, in relevant part, incorporated herein by reference; the citation of any document is not to be construed as an admission that it is prior art with respect to the present invention.

The color or appearance of a cellulose fiber paper is typically described in terms of four parameters; L value, a value, b value, and brightness. L is a measure of how light paper appears and varies from 100 for perfect white to zero for black. The a value is a measure of how red or green paper appears, a positive a value is a shift towards red, a negative a is a shift towards green. The b value is a measure of how blue or yellow paper appears; a positive b value is a shift toward yellow and a negative b value is a shift toward blue. Brightness is a measure of reflected light intensity measured at 457 nm, which relates to the blue part of the spectrum. L, a, and b (or a*, b* depending upon the instrument used to take measurements) are measured by breaking down reflected light into four quadrants: blue, green, yellow and red. The intensity of light in each of these quadrants is represented by the +/−a or b value.

The appearance of base stock upon which a high quality image is printed is an important property, particularly in the field of photography or for photo quality images created by digital means, i.e. ink jet, dye sublimation, etc. High quality base stock for these applications generally has a bright blue-white appearance, achieved by fiber bleaching and the addition of various colorants and fluorescent whitening agents (FWA) or optical brightening agents (OBA), during manufacture. Many of these materials are supplied to the paper making industry and product selection can depend on base stock properties and other requirements. Regardless of what materials are used, they must not be susceptible to significant changes in color upon exposure to light and or heat.

Testing color stability of a high quality base stock consists of exposing samples to a light source of controlled intensity, in a controlled environment, for a specified period of time. During the specified time period, color values of samples are measured at designated time intervals. In accordance with one method for testing color stability, samples are exposed to simulated sunlight through glass in a chamber maintained at about 35° C. for three days. Examples of equipment that can be used for this testing are the SunTest Light Chamber and the Gardner Colorguard Light Booth.

For purposes of the present invention, coated papers are considered stable if stability results for the coated papers are comparable to the results obtained with the uncoated base stock. Comparable samples would appear to be within normal color variations for a specific type or grade of paper. Comparable test samples will typically have a difference in L values of less than about 0.5, preferably less than about 0.3, a difference in b values of less than about 3, preferably less than about 2 and/or a difference in brightness of less than about 3, preferably less than about 2 brightness units.

U.S. Pat. No. 6,482,581 and U.S. Pub. No. 2001/0026869 describe the coating of a cellulose base stock to make it smoother with fewer pits and subsequently allow for higher speeds in subsequent processing steps. In the art of making coated papers, it is well known that coating improves smoothness, particularly when the coated paper is subsequently calendered. Coating formulations have numerous components that are required for a coating to function as required. Pigments such as calcium carbonate, barium sulfate, talc, inorganic metal oxides, and kaolin clays and the like generally make up the bulk of a coating. Inorganic pigments such as those manufactured from styrene and acrylic monomers are also used. Binders, natural and synthetic, are used to give strength to the coating pigment system and also to adhere a coating to the cellulose substrate that has been coated. Binders used in conventional paper coatings can be selected from groups such as modified and unmodified starches, polyvinyl alcohols, styrene-butadiene, acrylics, styrene-acrylics, and others known in the art of coating. Binders for most coated products are selected for properties of strength, cost, and the ability to be printed on by various methods, such as gravure, offset, inkjet, etc.

For a non-typical coating application such as photographic base stock, binder selection is determined by numerous specific requirements of the coated base stock. The coating must be comparable to the uncoated base stock for color stability, must not interfere with the photo developer chemicals, must not allow edge penetration of the developer solution, must provide adhesive strength between coating pigments, and must provide adhesive strength between coating and subsequently applied polymer or other coatings.

The pigment coating composition of the present invention may include binders and pigments typically used in pigment coatings as would be known to those skilled in the art. Examples of pigments that may be included in the pigment composition include, but are not limited to, calcium carbonate pigments, clay, titanium dioxide, aluminum silicate, magnesium silicate, magnesium carbonate, zinc oxide, talc, satin white, barium sulfate, calcium silicate, zinc hydroxide, etc. and mixtures thereof.

Examples of binders found to provide the necessary color stability include, but are not limited to, acrylic, vinyl acrylic, styrene acrylic, and vinyl acetate.

In accordance with one aspect of the present invention, the binder used in the coating is an acrylic latex. Examples of acrylic latexes, include but are not limited to, acrylic esters, modified acrylic esters, acrylic ester co-polymers, and modified acrylic ester co-polymers. Examples of useful binders include Rhoplex B-15P, Rhoplex P-554, and Rhoplex 60-A. A particularly preferred acrylic latex is Rhoplex B 15-P available from the Rohm and Haas Company. The binder is usually used in an amount of about 8% to 30% by weight, more particularly, about 15% to about 25% by weight, based on the total solids content of the coating. For some applications, the binder may be used in amounts ranging from about 20% to about 30% binder by weight. The pigment to binder ratio may range from about 100:15 to about 100:40, more particularly from about 100:20 to about 100:30.

The base stock of the present invention may be used in any image forming system in which a smooth base sheet is required to provide a high quality image. By way of example, it may be used in conjunction with photosensitive emulsions, water or pigment-based ink receptive layers, thermal dye-recording layers, or other specialty coatings appropriate for a given imaging method. More particularly, a base stock produced in accordance with the present invention can be converted into photographic products or used to produce photographic ink jet products.

Base stock for papers that produce high quality images require exceptionally smooth surfaces. Fiber used in the manufacture of these papers is generally natural cellulose fiber, but synthetic fiber may also be used. The base stock can be produced on a Fourdrinier or cylinder paper machine. In accordance with one aspect of the present invention, a raw base sheet is formed using fibers as described in commonly assigned and contemporaneously filed U.S. application Ser. No. ______, entitled “SMOOTH BASE STOCK COMPOSED OF NONSTANDARD FIBERS.” Any conventional sizing and bonding agents can be used in manufacture of the raw base stock. The raw paper may contain pigments and filling agents such as clay, calcium carbonate or titanium dioxide, as well as additional auxiliary substances such as defoaming agents, optical brighteners and coloring agents. The basis weight of the raw base paper will typically be from about 50 to about 250 g/m², more particularly from about 100 to about 200 g/m².

The pigments useful in accordance with the present invention are not particularly limited and any pigments can be used which are suitable for the end use application of the coated paper. In accordance with certain embodiments of the invention, the pigment coating contains pigments which are particularly useful in improving smoothness of the base stock as described in commonly assigned and contemporaneously filed U.S. application Ser. No. ______, entitled “PIGMENT SELECTION FOR COATED PHOTOGRAPHIC BASE STOCK.” Examples of the pigments useful in accordance with this aspect of the present invention include, but are not limited to, anisotropic particles in the form of needle-shaped aragonite precipitated calcium carbonate, high-aspect-ratio clay, low bulk density pigment in the form of hollow sphere polystyrene pigment and combinations thereof. In accordance with a more specific aspect of the present invention, a specific pigment formulation comprising a combination of these pigments is provided. By providing a particular range of concentrations of needle-shaped precipitated calcium carbonate, hollow sphere polystyrene pigment and high-aspect-ratio clay, the roughness of a coated photographic base paper can be minimized. In accordance with a particular embodiment of the invention a pigment coating containing from about 10 to about 14% high aspect ratio clay, from about 18 to about 22% hollow sphere polystyrene pigment and from about 65 to about 75% aragonite precipitated calcium carbonate based on total pigment weight can be used to minimize surface roughness. The present invention provides levels of smoothness that are not typically attained using prior art techniques.

In accordance with another particularly useful embodiment of the invention, a coated paper is provided having a pigment coating containing from about 20 to about 30% of an acrylic binder, from about 40 to about 80% of aragonite precipitated calcium carbonate and from about 15 to about 25% hollow sphere polystyrene pigment by weight based on the dry pigment coating.

The pigment coating as described herein may be applied to the uncoated base stock using any conventional coating devices, such as a gate roll coater, a bill blade coater, an air knife coater, and the like. The pigment coating will typically be applied to provide a coat weight of from about 4 to about 15 lb/3300 ft², more particularly from about 8 to 10 lb/3300 ft².

After being formed and dried on the paper machine to form a web, or after applying the pigment coating to the base stock, final smoothness of the base stock or coated paper is generally achieved by subjecting the web or coated paper to various smoothing operations. One particularly useful method involves a densification process known as calendering, during which a paper web is passed between nips formed by multiple rolls stacked upon one another, creating pressure to compress the paper and make it smoother. Generally, the compression step is accomplished with a stack of four or more metallic rolls (U.S. Pat. No. 5,060,565). In such a stack, the nip load and compression force increase in each successive nip from the top down due to the weight of the rolls and whatever additional load force is applied. In U.S. Pat. No. 5,200,258, a process is described using a nip formed by two rolls of dissimilar material (i.e. metallic and a polymeric resin covered roll) followed by a nip formed by two metallic rolls. This is a process used for production of standard base stocks as well. In accordance with certain aspects of the present invention, the paper may be compressed by a succession of nips formed by either a polymeric resin covered roll and a metallic roll or by two metallic rolls. It is known in the art of calendering that a nip formed by a polymeric covered roll and a metallic roll will give improved fine scale smoothness to the web contacting the polymeric covered roll. A nip formed by two metallic rolls will improve large to medium scale roughness resulting from paper formation-related roughness. In accordance with a particular embodiment of the present invention, the smoothing operation involves passing the paper web or coated paper through a plurality of nips in a calender stack wherein the first nips are formed by polymeric covered rolls adjacent to metallic rolls and the last two nips are formed by pairs of adjacent metallic rolls. Therefore, the fine scale smoothness is improved initially with the large and medium scale smoothness improved in the last two nips. A means is employed to control nip pressures so calender roll weight and loading pressure are not the only factors in determining individual nip loads. The described calendering sequence allows a high level of smoothness without a blackening effect that can occur when paper is calendered through multiple metallic nips.

Coated paper in accordance with the present invention is advantageous due to the improvement in smoothness obtained using the described coating composition. Smoother papers provide images of higher quality in most image forming operations. Smoothness of photobase paper is particularly important for generating high quality images. The surface roughness or Ra of the base stock or coated paper is a measure of relatively finely spaced surface irregularities on the paper. Ra represents the center line roughness of the base stock or finished paper. The surface roughness measurement provides an indication of the maximum variations over the surface of the paper. Lower Ra values indicate smoother base stock or coated paper.

In accordance with one aspect of the present invention, the base stock is subjected to a smoothing operation to provide a base stock or coated paper having a roughness of from about 1.2 micron Ra to about 1.5 micron Ra. Calender loads typically range from about 1000 pli to about 1500 pli to produce base stock having the desired smoothness. Ra represents the center line roughness of the base stock or finished paper. Ra is preferably 3.0 microns or less, more preferably 2.0 micron or less and most preferably 1.5 micron or less.

In accordance with certain embodiments of the present invention, the pigment coated paper is further coated with a polymeric resin layer on one or both sides of the coated paper. The polymer film is typically applied to the coated paper by an extruding or laminating process although any method of coating the polymeric film to the base stock to provide a smooth surface can be used. One or more coating layers of polymer can be applied to the paper. The polymers useful in accordance with this aspect of the invention are not particularly limited provided the polymer is capable of being extruded, laminated or coated onto the paper base stock.

Polyolefin resins typically are used in producing a photographic support to which a photosensitive emulsion is applied. Polyolefin resins useful in forming the polyolefin resin layer include homopolymers of olefins such as low density polyethylene, high density polyethylene, polypropylene, polybutene, polypentene, copolymers of two or more olefins and mixtures thereof. Polymers of various densities and melt indices can be used. Polyester resins or films may also be used in producing a photographic support. The polymer resin layer may also include other additives such as pigments, amides, metal salts of aliphatic acids, antioxidants, brighteners, ultraviolet absorbers, etc. Titanium dioxide is frequently added to the polymer resin layer to improve sharpness and image resolution. U.S. Pat. No. 4,994,357 to Uno et al. describes various polyolefin coating compositions and the use of the compositions in producing photographic supports.

The polymer layer may be applied to provide a dry coat weight of from about 5 to about 30 lb/3300 ft², more particularly from about 15 to about 25 lb/3300 ft². The polymer layer can be extruded as a single layer or co-extruded as a multi-layer.

The present invention is illustrated in more detail by the following non-limiting examples.

### EXAMPLES

Binder Comparison:

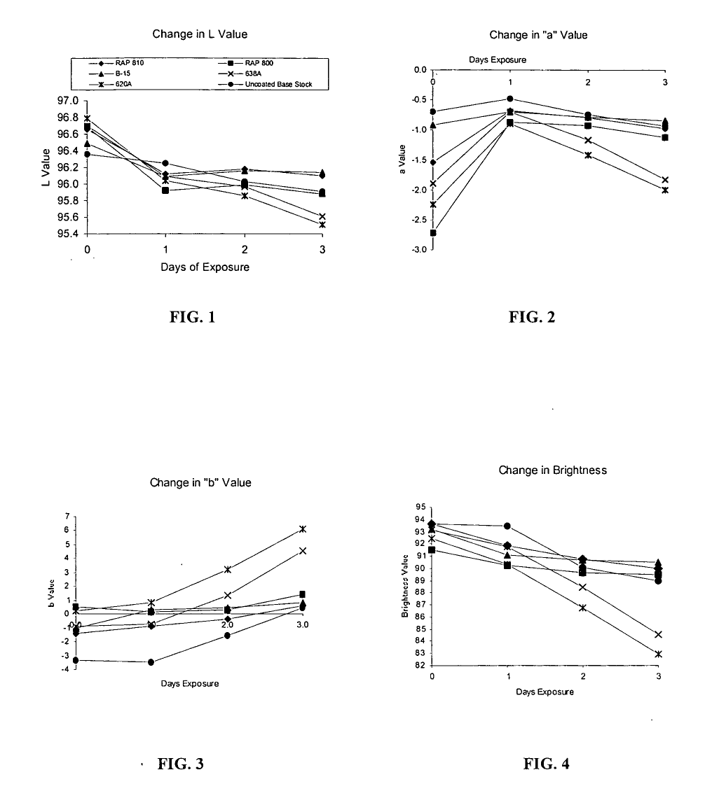

Coatings were prepared using five different binders representative of binders used in example coatings from U.S. Pat. No. 6,482,581 and U.S. Pub. No. 2001/0026869 and binders of coatings in accordance with the present invention. Table 1 shows the coating composition of example coatings. The coatings were applied onto base stock appropriate for photographic use and tested for color stability. Testing was conducted in a SunTest Light Chamber for a period of three days. The light source was simulated sunlight through glass; chamber temperature was maintained at 35 deg C. (95 deg F.). Color measurements were taken and the results are shown in FIGS. 1 to 4.

After three days of testing, the figures show changes in L, a*, b* and brightness of sample coatings made with acrylic or styrene-acrylic binders to be comparable to the uncoated base stock. Compared to the uncoated base stock and samples coated with binders A, B, and C, comparative samples D and E with the styrene-butadiene latex as binder had considerably more loss in brightness, had lower L values indicating a greater loss of whiteness, were much more yellow (b* value), and had a more green coloration (a* value). These results demonstrate that the coating formulations described in U.S. Pat. No. 6,482,581 and U.S. Pub. No. 2001/0026869, containing styrene-butadiene binder, would not meet base stock color stability requirements for use as photographic paper or other like applications where a bright white appearance is required and must be maintained.

Examples for Color Stability Testing:

Coatings shown in Table 1 were prepared and applied onto base stock using drawdown rods.

TABLE 1

| | % of | Coating 1 | Coating 2 | Coating 3 | Coating 4 | Coating 5 |
|---|---|---|---|---|---|---|
| Coating Component | Coating | Invention | Invention | Invention | Comparative | Comparative |
| Calcium Carbonate (1) | 66 | H-90 | H-90 | H-90 | H-90 | H-90 |
| Styrene-acrylic pigment | 11.5 | HS-3000 | HS-3000 | HS-3000 | HS-3000 | HS-3000 |
| (2) | | | | | | |
| Synthetic Binder (3) | 19.4 | Binder A | Binder B | Binder C | Binder D | Binder E |
| Starch (4) | 2.3 | PG 260 | PG 260 | PG 260 | PG 260 | PG 260 |
| Salt | 0.22 | NaCl | NaCl | NaCl | NaCl | NaCl |
| Dispersant (5) | 0.19 | Alcosperse | Alcosperse | Alcosperse | Alcosperse | Alcosperse |
| FWA | 0.39 | T-100 | T-100 | T-100 | T-100 | T-100 |

(1) H-90 is a ground calcium carbonate sold by Omya
(2) HS-3000 is a hollow sphere pigment sold by Dow Chemical
(3) Binder A is a styrene-acrylic binder, RAP 810, sold by Dow Chemical Binder B is a styrene-acrylic binder, RAP 800, sold by Dow Chemical Binder C is an acrylic binder, R-15, sold by Rohm and Haas Chemical Binder D is a styrene-butadiene, 638A, sold by Dow Chemical Binder E is a styrene-butadiene, 620A, sold by Dow Chemical
(4) PG260 is an ethylated starch sold by Penford Products Company
(5) Alcosperse is polymer dispersant, sold by Alco Chemical

The polyvinyl alcohol class of materials also provides binding strength along with color stability but generally would not be used as a sole binder in a mineral based coating but may be used in conjunction with a non-yellowing binder as described in the invention examples.

Edge Penetration: When mineral pigments or organic spherical pigments are packed together, the structure formed contains numerous voids between the individual particles. These voids readily absorb liquid when in contact with a fluid. A binder material added to a coating holds these particles together and adheres the coating to the cellulose substrate. To test for edge penetration, a base stock sample is coated with a polymer coating by means of a laminator or extruder. Polymer coated samples are cut into approximately 5.0 cm squares and placed in a heated bath of photo developer. After a set period of time the samples are removed from the bath and placed in a drying oven, where the heat of the oven accentuates any discoloration that may have occurred along the edge of the sample due to penetration of the developer solution. Developer solution temperature and time of sample immersion can vary according to the desired severity of the testing.

Coatings were prepared with differing binder to pigment ratios; formulations and edge penetration results are shown in Table 2. Edge penetration testing was conducted in a 75 deg C. (167 deg F.) developer bath for 10 minutes followed by 10 minutes in a drying oven at 105 deg C. (221 deg F.). Relative edge penetration within the samples was judged visually. A clear improvement in edge penetration resistance was obtained with increasing amounts of binder. Binders are more expensive than mineral pigments so optimization of binder amount is important. Impact of pigment particle size is also indicated by the data. Larger particle size carbonate pigment gave better edge penetration at comparable binder content. Smaller particles will pack more closely but have a greater number of voids of smaller size; smaller size voids will have greater capillary action for filling with a liquid.

Examples for edge penetration testing:

TABLE 2

| | | | Edge |
|---|---|---|---|
| | | | Pene- |
| Percent Coating Pigment | Binder Content | Binder:Pigment | tration |
| 68% Calcium carbonate A | 9% Styrene- | 1:10 | Poor |
| 23% Styrene-acrylic | butadiene | | |
| pigment | binder D | | |
| 62% Calcium carbonate A | 17% Styrene- | 2:10 | Good |
| 21% Styrene-acrylic | butadiene | | |
| pigment | binder D | | |
| 58% Calcium carbonate A | 23% Styrene- | 3:10 | Excellent |
| 19% Styrene-acrylic | butadiene | | |
| pigment | binder D | | |
| 68% Calcium carbonate B | 9% Styrene- | 1:10 | Good |
| 23% Styrene-acrylic | butadiene | | |
| pigment | binder D | | |
| 62% Calcium carbonate B | 17% Styrene- | 2:10 | Excellent |
| 21% Styrene-acrylic | butadiene | | |
| pigment | binder D | | |
| 58% Calcium carbonate B | 23% Styrene- | 3:10 | Excellent, |
| 19% Styrene-acrylic | butadiene | | none |
| pigment | binder D | | |
| 68% Calcium carbonate C | 20% Styrene- | 2.5:10 | Excellent |
| 12% Styrene-acrylic | acrylic | | |
| pigment | binder A | | |

Calcium carbonate A, ground carbonate with a nominal particle size diameter of 0.7 micron
Calcium carbonate B, ground carbonate with a nominal particle size diameter of 1.8 micron
Calcium carbonate C, precipitated carbonate, needle shape

Having described various aspects and embodiments of the invention and several advantages thereof, it will be recognized by those of ordinary skills that the invention is susceptible to various modifications, substitutions and revisions within the spirit and scope of the appended claims.

1. A method for producing a coated paper for use in forming a recording material comprising the steps of:
providing a base stock; and
coating the base stock on at least one side thereof with a pigment coating composition comprising an acrylic binder to produce a coated paper exhibiting color stability comparable to the uncoated base paper.

2. The method in accordance with claim 1 wherein the acrylic binder is selected from the group consisting of acrylic esters, modified acrylic esters, acrylic ester co-polymers, modified acrylic ester co-polymers and mixtures thereof.

3. The method in accordance with claim 1 wherein the binder is present in the pigment coating composition at from about 8 to about 30% by weight of the dry coating.

4. The method in accordance with claim 1 wherein the pigment coating coat weight is from about 4 to about 15 lb/3300 ft².

5. The method in accordance with claim 4 wherein the pigment coating coat weight is from about 8 to about 10 lb/3300 ft².

6. The method in accordance with claim 1 further comprising subjecting the coated basestock to a smoothing operation to provide a coated paper having a roughness of not more than about 1.5 micron Ra.

7. The method in accordance with claim 6 wherein the acrylic binder comprises a styrene acrylic binder.

8. The method in accordance with claim 7 wherein the binder is present in the pigment coating composition at from about 20 to about 30% by weight of the dry coating.

9. The method in accordance with claim 1 wherein the pigment coating further contains a pigment selected from the group consisting of calcium carbonate pigments, clay, titanium dioxide, aluminum silicate, magnesium silicate, magnesium carbonate, zinc oxide, talc, satin white, barium sulfate, calcium silicate, zinc hydroxide and mixtures thereof.

10. The method in accordance with claim 1 further comprising coating at least one side of the coated paper with an image forming or image receptive coating layer wherein the image forming or image receptive coating is selected from the group consisting of a photosensitive emulsion, an ink jet receptive coating, a thermal dye recording layer and a pigment based ink receptive layer.

11. The method of claim 10 further comprising coating the coated paper with a polymeric resin layer on at least one side of the coated paper.

12. The method of claim 11 wherein said polymeric resin layer comprises a polyolefin or a polyester.

13. A support material for an image forming system comprising a coated paper wherein the coated paper comprises:
a base paper having a pigment coating on at least one side thereof wherein the pigment coating comprises an acrylic binder; and
an image forming or image receptive coating layer on at least one side of the coated paper wherein the image forming or image receptive coating is selected from the group consisting of a photosensitive emulsion, an ink jet receptive coating, a thermal dye recording layer and a pigment based ink receptive layer,
wherein the coated paper exhibits color stability comparable to the uncoated base paper.

14. The support material in accordance with claim 13 wherein the support material further comprises a polymeric coating layer disposed between the pigment coating on the coated paper and the image forming or image receptive coating layer on one or both sides of the support material.

15. The support material in accordance with claim 14 wherein the polymeric coating layer comprises a polyolefin or polyester coating layer.

16. The support material in accordance with claim 13 wherein the pigment coating coat weight is from about 4 to about 15 lb/3300 ft².

17. The support material in accordance with claim 13 wherein the pigment coating comprises from about 20 to about 30% acrylic binder, from about 40 to about 80% aragonite precipitated calcium carbonate and from about 15 to 25% hollow sphere pigment based on the dry pigment coating.

18. The support material in accordance with claim 17 wherein the pigment coating is substantially free of clay.

19. The support material in accordance with claim 13 wherein the pigment to binder ratio in the pigment coating is within the range from about 100:15 to about 100:40.

20. The support material in accordance with claim 13 wherein the acrylic binder is selected from the group consisting of acrylic esters, modified acrylic esters, acrylic ester co-polymers, modified acrylic ester co-polymers and mixtures thereof.

21. The support material in accordance with claim 20 wherein the support material has a surface roughness of not more than about 2.0 micron Ra.

22. The support material in accordance with claim 21 wherein the pigment coating comprises:
from about 10 to about 14% high aspect ratio clay, from about 18 to about 22% hollow sphere polystyrene pigment and from about 65 to about 75% aragonite precipitated calcium carbonate based on total pigment weight; and
from about 15 to about 25% of an acrylic binder by weight of the dry pigment coating.
